(19) United States
(12) Patent Application Publication
(10) Pub. No.: US 2016/0252279 A1
(43) Pub. Date: Sep. 1, 2016

(54) QUAD GENERATION OF ELECTRICITY, HEAT, CHILL, AND CLEAN WATER

(71) Applicant: MONARCH POWER CORP, Scottsdale, AZ (US)

(72) Inventor: Joseph Y. Hui, Fountain Hills, AZ (US)

(73) Assignee: MONARCH POWER CORP, SCOTTSDALE, AZ (US)

(21) Appl. No.: 14/765,958

(22) PCT Filed: Aug. 4, 2015
(86) PCT No.: PCT/US15/43674

§ 371 Date: Aug. 5, 2015

Related U.S. Application Data
(60) Provisional application No. 62/033,195, filed on Aug. 5, 2014.

(51) Int. Cl. F25B 27/00; F24D 17/00; F24F 5/00; H02K 7/18

(52) U.S. Cl. CPC F25B 27/007; H02K 7/18; F24D 17/0015; F24F 5/0046

(57) ABSTRACT

An apparatus focuses solar power to provide clean energy, water, heat, and chill. Using ammonium carbonate salt for four purposes: first generating electricity using carbon dioxide as working fluid for a heat engine; second generating hot water from heat exchanges; third generating chill by evaporation of liquefied ammonia; and fourth generating purified water by forward osmosis with ammonium carbonate salt as draw solution.

### CLAIM OF PRIORITY

This application claims priority of U.S. Provisional Patent Application Ser. No. 62/033,195 entitled A Heat Engine for the Quad-Generation of Electricity, Chill, Heat, and Desalinated Water filed Aug. 5, 2014, the teachings of which are included herein incorporated by reference.

### FIELD OF THE INVENTION

### Energy

The present invention relates generally to the collection, storage, and conversion of energy, as well as the use of energy for applications such as water desalination, heating, chilling, and electricity generation.

### BACKGROUND OF INVENTION

Thermodynamic cycles are used for many purposes. Refrigeration uses a reversed Rankine cycle in which a liquefied refrigerant is evaporated to create chill. Heat engines uses a forward Rankine cycle in which an evaporating working fluid is superheated under pressure to generate motion in a heat engine. Forward osmosis uses a concentrated draw solution to draw pore water out of salty water for human consumption. Latent heat of gas and liquid and heat of condensation can be collected for heating up water. These four purposes can be combined in a complex cycle to generate electricity, heat, chill, and clean water. We call the invention disclosed here quad-generation.

An example of refrigeration is absorption chilling using ammonia as refrigerant. Ammonia is a highly soluble gas in water. Water can absorb up to 100 times its volume of ammonia gas. Once absorbed, the ammonia gas can be boiled off from the absorbent water in high heat. The boiled off ammonia creates a high pressure. Ammonia gas liquefies more readily in high pressure, once the heat that drove ammonia gas from its absorbent is removed. Liquefied ammonia is a refrigerant. When evaporated with reduced pressure, heat is absorbed from the environment, creating chill.

Steam engines are Rankine cycle heat engines. Water is evaporated and superheated to a high temperature and pressure to drive a piston. Heat energy is converted into work by means of the pressure of the superheated steam pushing against the piston. The exhaust steam must be cooled to condense back to water. Condensed water is heated in an enclosed boiler to repeat the cycle. Rankine cycle using steam turbine generates most of the world's electricity by coal fired power plants. These plants use a lot of cooling water. They contribute to global warming by injecting massive amount of carbon dioxide into the atmosphere.

Carbon dioxide is a better working fluid for Rankine cycle engines because it is inert. Water is corrosive. We prefer to use carbon dioxide as working fluid in a heat turbine, such as the Hui turbine disclosed U.S. Pat. No. 9,035,482 herein incorporated by reference. Work expended carbon dioxide can be absorbed by an ammonium solution as we propose in this invention. In coal fired power plant, steam is condensed in cooling towers using a large amount of water. Such use of water is not sustainable. Our choice of carbon dioxide as working fluid condensed by absorption will save a lot of water.

Instead of using pressure or chill to liquefy carbon dioxide, carbon dioxide is readily absorbed in ammonium solution. Absorbed carbon dioxide in ammonium solution is ionized as carbonate or bicarbonate ions. Ammonium carbonate and ammonium bicarbonate dissociates into ammonium ions, carbonate ions, and bicarbonate ions in the aqueous solution. Other forms of ammonium carbonate salt such as ammonium carbamate are described in the chemistry literature. We refer to all forms of such salts generically as ammonium carbonate salt.

Ammonium carbonate salt crystallizes as we chill its solution. A convenient way to capture carbon dioxide is to spray an atmosphere of carbon dioxide with ammonium solution. This method has been used for carbon sequestration of carbon dioxide in coal fired power plants. Absorbed carbon dioxide can be expelled by heat and further sequestered in ground.

Ammonium carbonate solution can also be used as a draw solution for forward osmosis. Osmosis is the movement of solvent across a membrane that is permeable to the solvent but not the solute. Solvent moves from a low concentration solution to a higher concentration solution through that semi-permeable membrane. Osmosis stops when the concentration of solute on both sides of the semi-permeable membrane is equalized.

Forward osmosis uses a solution of higher molar concentration of solute than the solution from which the solvent is drawn from. The solute needs not be the same on either side. For example we can use a strong sugary water with a high molar concentration of sugar to draw water from seawater with a lower molar concentration of dissolved salt. Diluted sugar water is fit for human consumption.

We use ammonium carbonate as draw solute instead of sugar. Ammonia carbonate salt in the draw solution can be expelled by means of heat. Ammonia carbonate solution decomposes into ammonium bicarbonate solution with expulsion of carbon dioxide at around 50° C. Beyond 90° C., an ammonium bicarbonate molecule decomposes into an ammonia gas molecule, a carbon dioxide gas molecule, and a water molecule.

We note that the same heat expulsion is used to drive ammonia from a strong ammonium solution in ammonia absorption chilling. In our invention for the purpose of chilling, we use an ammonium carbonate solution instead of ammonium solution.

The key idea is that ammonium solution can help carbon dioxide condense as ammonium carbonate, without the use of high pressure or low temperature to liquefy carbon dioxide. Though it requires more energy to expel both ammonia and carbon dioxide from ammonium carbonate solution, we have two added advantages besides chill generation. We can produce clean water as well as use the heat to drive out carbon dioxide for powering a turbine.

We note that the same heat expulsion process generates high pressure for both ammonia and carbon dioxide. The generated pressure is useful for liquefying ammonia. The pressurized carbon dioxide is also useful for driving a turbine, particularly when the pressurized gas is further heated by say concentrated solar power or by combusted fossil fuel.

We note that the liquefaction of ammonia gives out substantial amount of latent heat of condensation. This latent heat can be used to produce hot water.

We note that the carbon dioxide molecule is less electrically polarized than the ammonia molecule. Therefore, carbon dioxide has a much, lower temperature of condensation than ammonia for the same ambient pressure. This is a use fill mean to purify the expelled gas. Ammonia liquefies under high pressure and ambient temperature, while carbon dioxide remains as a gas under the same conditions.

We note that carbon dioxide molecule has molecular weight of 44. Ammonia molecule has molecular weight of 17. Therefore a mixture of these two gases readily separates as ammonia rises while carbon dioxide falls. Rising ammonia is cooled outside the generation chamber of gases and condenses further in a chilled chamber.

These two gases can be separated as the gases are not miscible. This separation is similar to the process of fractional distillation to separate various gasified components of crude oil. Lighter fluids and gases come out at the top of the fractional distillation column, while heavier molecules such as kerosene and tar come out near the bottom of the column.

This disclosure reveals a synergy of the four purposes of generating heat, chill, electricity, and purified water through combined use of ammonia and carbon dioxide as gases, as well as the affinity of carbon dioxide and ammonia for absorption in water. We call this process quad-generation.

In the remainder of this background description, we will look at the basic chemistry behind our invention.

Ammonium carbonate salts include crystalline ammonia carbonate (NH₄)₂CO₃ used for baking, and ammonium bicarbonate (NH₄)(HCO₃) also called salt of Hartshom. There are other forms of crystalline ammonium carbonate salt such as ammonium carbamate (NH₄)(CO₂)(NH₂). These and other derivatives are generically called ammonium carbonate salts in this disclosure.

Ammonium carbonate salts are soluble in water H₂O to dissociate into ammonium sons NH₄⁺, carbonate ions CO₃²⁻, and bicarbonate ions HCO₃⁻. The ratio of these ions depends on the kind of ammonium carbonate salt dissolved and the temperature of the solution.

As a crystal or a solution, ammonium carbonate salts smell like pungent ammonia, because heat readily decomposes these salts. The decomposed gaseous forms of the salt are ammonia NH₃, water H₂O, and carbon dioxide CO₂.

Ammonia gas molecule, being polar due to its non-uniform distribution of electrons, is highly soluble in water, which is another highly polar molecule. Water can absorb many times its volume of ammonia gas.

Carbon dioxide gas molecules are non-polar due to its linear structure of two oxygen atoms lined up on either sides of a carbon atom. Carbon dioxide is not as soluble as ammonia in water. Under pressure such as in soda water, carbon dioxide solubility increases but still trails that of ammonia.

Carbon dioxide is more soluble in ammonium solution due the abundance of hydroxyl ions OH⁻. The solution of ammonia in water produces hydroxyl ions in the reaction NH₃+H₂O→NH₄⁺+OH⁻. The hydroxyl ion bonds with carbon dioxide to form bicarbonate ions in the reaction CO₂+OH⁻→HCO₃⁻. If there is an overabundance of ammonia in the solution, the bicarbonate ion loses its hydrogen ion to form a carbonate ion in the reaction HCO₃⁻+NH₃→CO₃²⁻+NH₄⁺.

These dissolved ions crystallize when the solution is chilled, precipitating out the ammonium carbonate salt through the reaction CO₃²⁻+2(NH₄⁺)₂(CO₃²⁻). This crystallization and previous absorption processes are methods for sequestering carbon dioxide. These methods take advantage of the affinity of ammonia with carbon dioxide. This affinity property is used for the purpose of sequestering carbon dioxide in a solid form without the use of pressure to liquefy carbon dioxide.

Ammonia gas becomes a liquid at atmospheric pressure when temperature is reduced to −33.3° C. Ammonia becomes liquid at room temperature (300K or 27° C.) if pressurized to 10 bars. Ammonia can be used for compressive air conditioning with liquefaction under pressure. The liquefied ammonia when evaporated absorbs a large amount of heat. The latent heat of evaporation is 23.35 kJ/mol. One mole of ammonia weighs 17 grams.

Carbon dioxide with its linear and non-polar electron distribution is harder to liquefy. At atmospheric pressure, carbon dioxide freezes from gaseous form to solid form without being liquefied. The sublimation point is the temperature when dry ice of carbon dioxide sublimes directly into gaseous form. That temperature is a low −78.5° C. The latent heat of vaporization of carbon dioxide is less than that of ammonia at 15.33 kJ/mol. A mole of carbon dioxide weighs 44 grams.

Carbon dioxide becomes critical at a temperature of 31° C. and pressure of 74 bars. Beyond that temperature and pressure, carbon dioxide becomes supercritical with no distinction between the liquid and gaseous phases. In this invention, we do not liquefy carbon dioxide. Carbon dioxide is heated to a temperature above 800K and pressurized somewhere between 10 to 20 bars. These conditions, combined with the highly efficient Hui turbine, can attain a thermodynamic efficiency of around 40% in converting heat to work.

Ammonia, with its ease of liquefaction, is a better refrigerant than carbon dioxide. Carbon dioxide has been used for extracting heat from the atmosphere to heat water from freezing to almost boiling in heat pumps. Carbon dioxide heat pumps are currently being planned for used in electric cars where both heat and chill are needed. The range of heating and chilling for carbon dioxide as a refrigerant is broader than that of ammonia.

Carbon dioxide is a better working fluid for heat engine than ammonia or steam. Carbon dioxide is much more inert than ammonia or water. Steam can be corrosive to metal and is abrasive when it condenses. Water requires a substantial amount of heat for evaporation, close to 2 kJ per gram at atmospheric pressure. This heat significantly reduces heat engine conversion efficiency. Worse, this heat of evaporation requires significant water resources for removing the heat of condensation.

The examination of chemical properties led us to choose carbon dioxide as the working fluid for the heat engine, ammonia as the working fluid for refrigeration, and ammonium carbonate as the draw solute for forward osmosis purification of water. We also reuse heat extensively by means of heat exchangers.

### SUMMMARY OF INVENTION

We summarize the disclosed invention as: a method of using a heat source for the quad-generation of heat, chill electricity, and clean water by the combined use of carbon dioxide and ammonia as refrigerant, heat engine working fluid, heat exchange fluid, and draw solute, taking advantage of the affinity of carbon dioxide and ammonia in a solution and the immiscibility of carbon dioxide and ammonia as gases.

We summarize the disclosed apparatus of using a heat source for the quad-generation of heat, chill electricity, and clean water, comprising a subsystem of heat collection, a subsystem of absorption of carbon dioxide and ammonia in water, a subsystem of forward osmosis by ammonium carbonate solution, a subsystem of regeneration of ammonia and carbon dioxide as hot and high pressure gases, a subsystem of heat exchange for condensing the pressurized gases, a subsystem for storing the condensed gases and use later for evaporative chilling, and a subsystem for converting the heat and pressure energy of a gas into work through a turbine that drives an electric generator.

We summarize the disclosed apparatus of using a heat source for tri-generation of heat, chill, and electricity based on the quad-generation method except concentrated or crystalline ammonium carbonate is directly heated to created high pressure carbon dioxide and ammonia without using ammonium carbonate as a draw solution for water purification.

### BRIEF DESCRIPTION OF THE DRAWINGS

FIG. 1 illustrates the quad-generation system of electricity, heat, chill, and clean water.

FIG. 2 illustrates improvements on the Hui turbine.

FIG. 3 illustrates vacuum distillation to remove ammonia from desalinated water.

FIG. 4 illustrates the tri-generation system of electricity, heat, and chill.

FIG. 5 shows the vapor pressure of ammonia versus pressure.

FIG. 6 shows the vapor pressure of carbon dioxide versus pressure.

### DETAILED DESCRIPTION

Our invention uses ammonium carbonate salts in its various states and forms for the quad-generation of heat, chill, purified water, and power using thermal energy from concentrated solar power or from the burning of fossil fuel.

Concentrated solar power could provide clean energy, water, heat, and chill to off-grid community and underdeveloped countries. We invent an apparatus that uses ammonium carbonate salt for four purposes: first the generation of electricity using carbon dioxide as working fluid for a heat engine; second the generation of hot water from heat exchanges; third the generation of chill by evaporation of liquefied ammonia; and fourth the generation of purified water by forward osmosis with ammonium carbonate salt as draw solution. We first absorb ammonia in water. We then use ammonium solution to sequester carbon dioxide. The resulting ammonium carbonate solution is used as a draw solution for forward osmosis, extracting purified water from water with solute such as sea salt. Heat is then used to decompose the diluted ammonium carbonate solution into ammonia and carbon dioxide gases. Remaining water is purified further for human consumption. Heat also generates pressure in the gases expelled. When heat in the pressurized ammonia is removed, ammonia is liquefied. Liquefied ammonia when evaporated produces chill. The remaining gas after ammonia liquefies is pressurized and hot carbon dioxide. We heat the pressurized carbon dioxide further by concentrating solar energy or combusting fossil fuel. The heated carbon dioxide drives a turbine to produce work for turning an electricity generator. We use the heat of carbon dioxide exhaust from turbine to generate ammonia and carbon dioxide from ammonium carbonate solution. We extensively use heat exchanger to enhance efficiency and to produce hot water.

A reduction of the quad-generation uses ammonium carbonate salts in its various stales and forms for the tri-generation of heat, chill, and power using thermal energy from concentrated solar power or from the burning of fossil fuel. The crystallizing and concentrated ammonium carbonate solution is not used as a draw solution for purifying water with undesirable solute such as sea salt in seawater.

Another reduction of the quad-generation uses ammonia carbonate salts in its various states and forms for the tri-generation of heat, chill, and purified water using thermal energy from concentrated solar power or from the burning of fossil fuel. Carbon Dioxide is not used as a working fluid for heat turbine for converting pressure and heat energy of the gas into mechanical work.

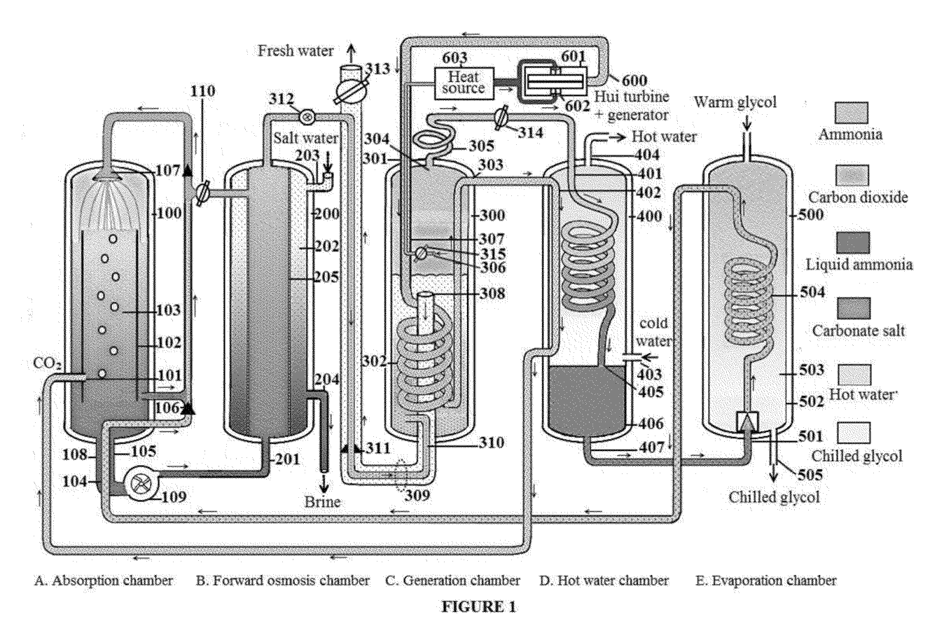

Various subsystem of the quad-generation system is shown in FIG. 1. The major subsystems are listed as follows. The absorption chamber 100 absorbs carbon dioxide into an ammonium solution for the purpose of creating a strong ammonium carbonate solution.

The osmosis chamber 200 takes in strong ammonium carbonate solution to be diluted by forward osmosis. The draw solution counter-flows against impure water such as salty seawater.

The generation chamber 300 serves two purposes. The first purpose is to expel the draw solute of the draw solution so that the diluted draw solution becomes purified. Residual ammonia after expulsion of most of the draw solute can be neutralized further, which is not shown in the figure. One method of ridding the remaining ammonia uses a membrane that is permeable to ammonia. Ammonia is then neutralized by sulfuric acid to form ammonium sulfate. Ammonium sulfate can be used as fertilizer for agriculture.

The second purpose of the generation chamber is to use heat to pressurize at 10 to 20 bars the expelled carbon dioxide and ammonia. The high pressure is used to liquefy ammonia. The pressure of carbon dioxide drives a heat engine.

The hot water chamber 400 cools down the ammonia gas. Cooled ammonia still under pressure liquefies. The liquefied ammonia is stored under pressure at the bottom of the hot water chamber. The carbon dioxide exhaust which was cooled by the generation chamber 300 is cooled further in the hot water chamber 400. Cooled carbon dioxide is easier to absorb in the absorption chamber 100.

The evaporation chamber 500 evaporates liquid ammonia, absorbing heat from the environment. The evaporation chamber serves as the chiller for the entire system.

The power generator 600 uses the superheated carbon dioxide as the working fluid to turn a turbine to generate electricity.

We now describe in detail the components of each of the above 6 subsystems. We also describe the relations between components of different subsystems.

The absorption chamber 100 takes in carbon dioxide at the intake nozzle 101. The carbon dioxide maintains a slightly higher than atmospheric pressure. This creates a circulation of fine bubble of carbon dioxide in the solution. This increases the dwell time of the carbon dioxide in inner tube 102. Increased dwell time enhances absorption of carbon dioxide in the solution 103.

Ammonia enters the chamber 100 at 104. This ammonia is chilled, which serves to cool down the solution for crystallization and/or dilution of ammonium carbonate. The ammonia then enters a cooling tube 105. The ammonia exits through the nozzle 106. The exit of ammonia creates a suction of solution upward. Ammonia begins to dissolve inside the cooling tube. The solution of ammonia in water after exiting the nozzle 106 generates heat. This heat of solution is passed to the environment. The liquid-gas mix exits at the top through the spray 107. The ammonium solution is sprayed onto an atmosphere of carbon dioxide.

Carbon dioxide not already absorbed in the inner tube 102 rises to the top, to be further absorbed by the sprayed ammonium solution. The solution in the inner tube rises and overflows the inner tube to enter the outer tube. The liquid level of the outer tube is monitored. If the liquid level drops too low, entry of gases and liquid into the tube may be stopped until the excess carbon dioxide inside the absorption chamber 100 is absorbed.

Chilled ammonium carbonate solution exits the chamber at 108. The chilled solution is pumped into the forward osmosis chamber 200 via the pump 109.

Depleted liquid in the absorption chamber 100 is replenished at 110 when the valve there is opened. The replenishing solution comes from diluted ammonium carbonate solution of the forward osmosis chamber 200.

The forward osmosis chamber 200 takes in strong ammonium carbonate solution in the inlet 201. This solution is weakened by osmosis of fresh water from the counter-flowing salty water 202 of a lower molar concentration of solute. The salty water enters at inlet 203. The salty water progressively becomes more briny. The brine is let out at 204 to be disposed of.

The forward osmosis membrane 205 allows the solvent to go from the salty solution side to the ammonium carbonate side with a higher molar concentration. One membrane that could be used is made of plant cellulose. Nature has used cellulose membranes for osmotic absorption of water into plants. Cellulose is a polymer form of sugar with good structural strength. It is relatively cheap and easy to replace. Reverse osmosis membranes have to withstand the high pressure pushing water from salty water onto the fresh water side of the membrane. Forward osmosis requires a lot less energy as osmotic pressure is generated by the osmotic gradient. The forward osmosis membranes do not have to withstand water pressure.

The generation chamber 300 decomposes the dissolved and diluted ammonium carbonate salt by means of heat. Heat is provided by the carbon dioxide exhaust from the turbine. Hot carbon dioxide enters through inlet 301. It yields its heat through heat exchange coil 302 and exits the chamber through outlet 303. The carbon dioxide still has sufficient latent heat to produce hot water in the hot water chamber 400.

Expelled ammonia rises to the top and exits the generation chamber at outlet 304. A small coil 305 allows water vapor, which should not have vaporized under a pressure between 10 to 20 bars, to condense and reflux back into the generation chamber. The expelled ammonia cools in the hot water chamber 400, heating up water in the process.

Expelled carbon dioxide sinks and is captured by the tube 306. It is heated inside tube 307 by the carbon dioxide exhaust from the turbine. This high pressure carbon dioxide is further heated by concentrated solar power or by burning fossil fuel. The superheated carbon dioxide serves as working fluid for the turbine.

Rid of ammonium carbonate, water now exits generation chamber through outlet 308. It goes downward through the heat exchanger 309, yielding heat to entering solution inside tube 310 that was diluted, in the forward osmosis chamber 200. At the bottom of the heat exchanger, the cooled water exits a nozzle 311 with its significant pressure released. The pressure release can release the residual ammonia in the water. The rising water yields further heat to the incoming diluted ammonium carbonate solution.

Any residual ammonia may be absorbed by allowing ammonia to flow across a membrane permeable to ammonia. Ammonia combines with sulfuric acid to form ammonium sulfate. Ammonium sulfate can be used as a fertilizer for growing food. Since a small amount of ammonia could be lost to make fertilizer, ammonia may have to be replenished periodically, for example through the injection of strong ammonia solution in the absorption chamber 100.

Valves are used to control pressure and allow gas and liquid exit. A high pressure pump 312 pumps the diluted ammonium carbonate solution from the forward osmosis chamber at a significant pressure exceeding 15 bar. The pressure inside the generation chamber should exceed 10 bars. Below 10 bars, the valves 313, 314, 315 close, preventing the exit of solution, carbon dioxide gas, and ammonia gas respectively. Above 20 bar pressure, these valves open to relieve pressure.

These valves are controlled for fluid flow as needed. For example valve 313 is opened when the fluid level in the absorption chamber 100 is low. Likewise, the gas valves 314, 315 are controlled for flow of ammonia and carbon dioxide as needed.

Control of the quad-generation system is centered at the subsystem of the generator chamber 300. Among the 5 chambers, the generator chamber operates at a higher pressure of 10 to 20 bars. Water boils at 180° C. at 10 bar pressure. Boiler temperature should not exceed 180° C. We do not want to boil off water, just ammonia and carbon dioxide.

At 50° C., most of the aqueous ammonium carbonate in the generator chamber 300 would dissociate into ammonium bicarbonate, giving out ammonia. This expelled ammonia is creates a moderate pressure in the generation chamber.

At temperature around 90° C., aqueous or crystalline ammonium bicarbonate start to decompose into carbon dioxide, ammonia, and water. Each ammonium bicarbonate molecule gives one molecule of each of the decomposed components. The carbon dioxide molecule would add vapor pressure.

Ammonia is still soluble at 180° C. at a high pressure, but solubility is much reduced. Driving out ammonia for the purpose of chilling becomes harder if the solution is too dilute. To recover ammonia effectively, we may have to limit the dilution of draw solution by forward osmosis.

There is therefore a tradeoff in the efficacy of desalination versus chilling. The same apparatus can facilitate this tradeoff by changing operating parameters. One control is to limit the amount of water drawn by forward osmosis. This control reduces water production to increase chill production.

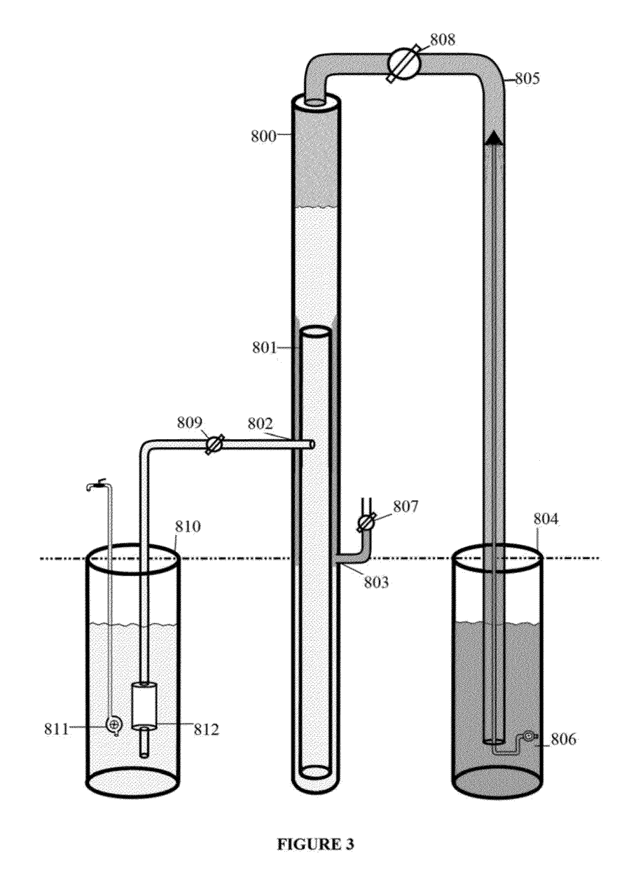

We can also limit the amount of ammonia regenerated in the generation chamber 300. The residual ammonia may be removed by other chemical means such as using sulfuric acid to capture ammonia as ammonium sulfate. However, this method would require replenishment of ammonia lost in the production of ammonium sulfate, a fertilizer. We prefer instead to use a vacuum chamber 800 shown in FIG. 3. Also, residual ammonia can be absorbed by active carbon filtration to provide even higher water purity for use as potable water.

The hot water chamber 400 cools down the expelled ammonia from inlet 401. Under a controlled pressure somewhere between 10 and 20 bars, the expelled ammonia liquefies. For example at 10 bar pressure, ammonia liquefies at room temperature of around 28° C.

Liquefaction gives out a significant amount of latent heat of condensation. If ambient temperature is high, a higher pressure may be needed for liquefaction of ammonia. A 15 bar pressure could condense ammonia at a temperature of 310K or 37° C. This higher pressure comes from expelled carbon dioxide, which does not liquefy. In traditional ammonia chillers, hydrogen gas is added to increase pressure for the liquefaction of ammonia.

We choose water cooling rather than air cooling which is often the case for ammonia chilling. Water usually has a lower ambient temperature than that of air. Water with a much higher latent heat capacity. Water can remove heat more effectively than air. Hot water is also more desirable than heated air.

The carbon dioxide exhaust from the turbine is further cooled down prior to absorption in the absorption chamber through inlet 402. The cooling agent is water, let in through inlet 403 and let out through outlet 404. The heated water is consumed as hot water.

Liquefied ammonia is collected at the bottom of hot water chamber 405. Storing liquefied ammonia in the closed chamber 406 is stable. If pressure is reduced, ammonia vaporizes. Vaporizing ammonia cools down the liquid. Vaporized ammonia in closed chamber also increases pressure, winch raises boiling point and thus prevents further vaporization.

Pressurized and liquefied ammonia is used for evaporation in the evaporation chamber 500. Liquefied ammonia exits the ammonia storage via exit 407.

The evaporation chamber 500 produces chill. Liquefied ammonia enters the chamber at inlet 501. A computer controlled nozzle 501 is opened to vaporize liquefied ammonia with suddenly released pressure. Evaporating liquefied ammonia requires a lot of heat, which is taken out from the chamber 502 containing an anti-freeze such as glycol 503.

The heat exchanger 504 chills the glycol. Chilled glycol exits the chamber through outlet 505. We prefer glycol to air as a chill transfer medium. Most likely the entire quad-generator is placed outdoor. Liquid chill transfer by glycol should be more efficient than chilled air transfer.

The chilled glycol could be used for refrigeration of food and medicine and air conditioning of living quarters. The evaporated ammonia remains cold. This leftover chill can be used to cool down the liquefied ammonia stored inside the hot water chamber. The cold ammonia gas can also cool down ammonium carbonate solution exiting at the bottom of the absorption chamber 100.

The power generator 600 has a turbine or heat engine coupled with an electricity generator. The Hui turbine 601 is integrated with an electricity generator.

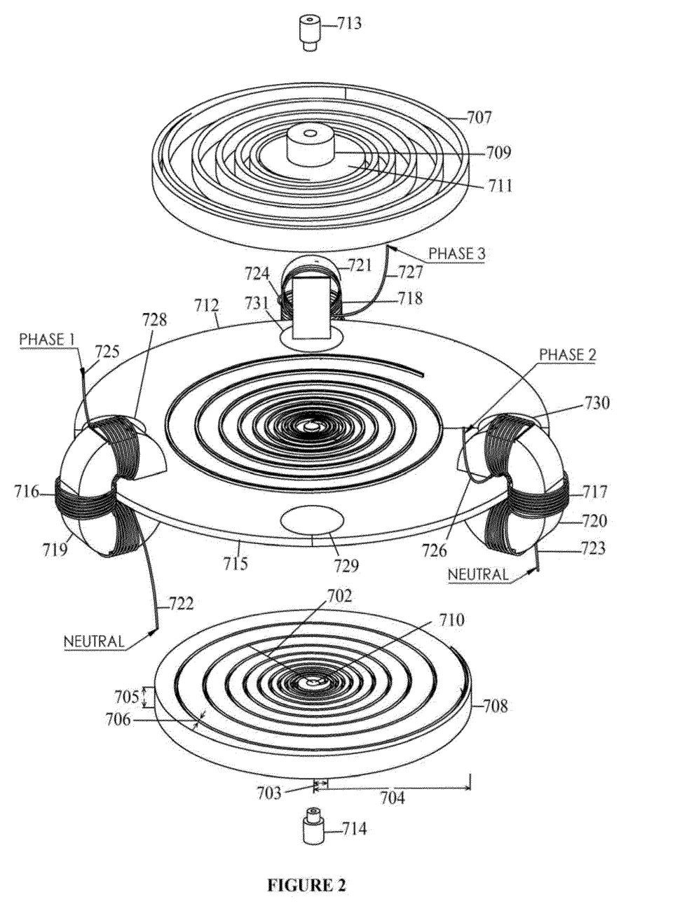

An improved Hui turbine is shown in FIG. 2. The exploded view shows both the turbine and the three-phase electric generator.

The first improvement is the shape of the turbine being an exponential spiral 701. The spiral radius is r(θ)=ae^{bθ} as a function of the turn angle θ. A radius is shown as 701. In this new implementation, we have chosen the coefficients a and b such that we have r(θ)=10^{θ/20π} in unit of centimeter for angle 0≦θ≦20π. In making 10 turns, radius increases in the range 1 cm≦r(θ)=10^{θ/20π}≦10 cm. The initial and final radii of 1 cm and 10 cm are marked respectively as 703 and 704. The spiral has a depth 705 of 1 cm and a thickness 706 of 1 mm. The spiral can be engraved with machinery or molded.

The second improvement is balancing the pressure forces on either side of two spirals 707 and 708. The gas intakes are two female ends 709 and 710. High pressure gas enters these ends. The thrust of gas entering these two ends is balanced. Gas enters the center cavity 711 and spins outward toward the exits at the perimeter of the spirals.

The two spiral 707 and 708 on two plates are joined together by the center plate 712, which separates the gas flow in the two spirals. The center plate fits the two spiral to minimize gas leak. The center plate is crested to fit the troughs of the spiral.

The gas injecting nozzles 713 and 714 make male coupling with the turbine gas intakes 709 and 710. This choice of male-female coupling creates the effect of an air bearing between the male nozzles and the female gas intakes. Not only is the gas pressure balanced, the air bearing allows smooth rotating of the turbine.

One important principle of the Hui turbine is to allow gas pressure to be released gradually. Sudden release of gas pressure by expanding nozzles such as the parabolic de Laval nozzle found in rockets causes the gas to accelerate. That's great for rocketry which throws out gas at high speed in empty space. On earth with an atmosphere, high speed gas creates turbulence and rapidly loses its kinetic energy before impacting turbine blades. That is why impact turbines are very entropic and inefficient.

The spiral is designed so that pressure is released gradually to push the spiral to turn in opposite direction of the spin of the gas. When the turbine is not spinning, the gas would have to make 10 turns before exiting the spiral. When the turbine is spinning very fast at its maximum velocity, the spinning of the turbine cancels out the spinning of the gas inside the turbine. The gas makes a beeline exit from the center to the edge.

The turbine generates useful work when the spin velocity of the turbine is about half or more of the maximum spin speed of the turbine. The exit velocity of gas is reduced by more than half of the velocity when the turbine is not spinning. If gas velocity is reduced by a factor of two or more, the energy of the gas is reduced by a factor of four or more. More than ¾ of the energy of the gas is now imparted to the turbine, resulting in a high isentropic efficiency.

The third improvement of the Hui turbine is integrating the rotor of the turbine 707 and 708 with the rotor 715 of an electric generator. The rotor 715 is located on the outside of the center plate 712. Since both the turbine and the electric generator have the same disk form factor, the two can be integrated. We do not need to use gear and coupler to transfer the rotational energy of the turbine to the electric generator.

The stator coils 716, 717, 718 are windings on C-shaped laminated cores 719, 720, 721. The bottom terminals of the coils 722, 723, 724 are grounded or connected together as neutral. The top terminals of the coils 725,726, 727 carry the voltages of each phase of three phase electricity.

For permanent magnet motors, rare earth magnets 728, 729, 730, 731 with alternating polarity (north pole facing up or down) of adjacent magnets are placed on the rotor of the electric generator 715. Permanent magnet motors has rotors turning synchronously with the driving AC frequency. The phase of rotation of the rotor lags that of the stator.

For induction motors, the rotor can be simply a metal plate, made of copper for its good conductivity. Magnetic field in the rotor is induced by the magnetic field of the stator. In generator mode, the rotor and stator mutually induce magnetic fields.

Inductor motors have rotors turning asynchronously with the driving AC frequency. The frequency of rotation of the rotor is lower than the frequency of rotation of the magnetic field generated by the stator.

We now consider the thermodynamic efficiency of the Hui turbine.

Hot and pressurized carbon dioxide from the generation chamber 300 is heated by the turbine exhaust which is at a temperature of about 500K or 227° C. in the heat exchanger 602. The temperature of the carbon dioxide is raised by about 50° C. through this heat exchange.

The carbon dioxide is heated tip further by a heat source 603 shown in FIG. 1. The heat source could be concentrated solar power melting a volume of sodium nitrate mixed with potassium nitrate at 550° C. or 820K. Temperature of carbon dioxide is raised by at least 300° C.

Theoretical efficiency ε of the turbine is around 40%

$$( ɛ = 1 - \frac{500 K}{820 K} = 0.39 ) .$$

The Hui turbine is a highly isentropic heat engine with isentropic efficiency exceeding 80%. The practical efficiency of the Hui turbine exceeds 0.39×80%=0.312>30%. This efficiency is 50% higher than the typical 20% efficiency for photovoltaic cells.

Efficiency can be much higher if natural gas is used to boost temperature beyond 1000K and pressure is increased to 20 bars. A thermodynamic analysis shows that temperature would drop to 1000K×(20)^{-2/7} or 425K with a theoretical efficiency of 57%. Practical efficiency can be brought to 45%. Thus use of natural gas can bring overall efficiency of work generation to be on-par with modern coal fired power plants.

The use of clean natural gas in the quad-generation system can be claimed to be zero carbon emission. Carbon dioxide generated from burning natural gas can be sequestered as ammonium carbonate by our quad-generator. The exhausted carbon dioxide from our turbine can be sequestered permanently underground.

Our quad-generation system is far superior to coal fired power generation. First, it can use totally renewable energy source. Second, it requires no transmission grid and no grid transmission loss of power. Third, the residual heat from turbine exhaust with temperature somewhere between 200° C. and 300° C. is useful for multiple purposes for generation of beat, chill and water generation. Overall energy efficiency of our system is around 80%.

We describe now the vacuum distillation system shown in FIG. 3. The purpose of the system is to remove the residual ammonia in the cooled output 313 of the generator chamber shown in FIG. 1.

The key to removing ammonia dissolved is to reduce the head water pressure in the main vacuum chamber 800 in FIG. 3. As an illustration, the size of the galvanized steel water tank is 2 feet in outside diameter and 30 feet in length. To provide stability, 10 feet of the tank is buried in the ground. The tank can be built from galvanized steel water pipes by closing off both ends of the pipe.

Inside a tank we provide a sheath tube 801 that is open at the top and bottom. The sheath tube can be made of plastic or a polymer. As an illustration, the outside diameter of the sheath tube is 18 inches with a length of twenty feet. The bottom end of the sheath tube is spaced slightly higher than the bottom of the tank 800.

The purpose of the sheath tube is to direct convection flow of water. The outside of the vacuum tank 800 is painted black or is naturally dark for steel pipes. The solar heated water rises between 800 and 801. Water circulates from between the tubes to inside the sheath tube and then back out to in between the tubes.

The solar heated water provides the energy needed to drive ammonia out of the tank. The height of the water head provides the reduced pressure so that ammonia would gas out of water easily. Water with removed residual ammonia is taken out at 802 from the center of the tank 800. Since 10 feet of the tank is buried in ground, the output at 802 is 5 feet above ground with a water pressure there at least equal the height of the water column inside 800 that is above 802.

Water from 313 of FIG. 1 is purified inside the vacuum tank, entering the tank at inlet 803 at the ground level. We release the pressure of the water at 803. The residual pressure would cause water level inside the tank to rise, force ammonia and water vapor above the water head to flow towards the refractory tank 804 through the outlet at the top of the vacuum tank 800.

The purpose of the refractory tank 804 is collection of ammonium solution that is distilled from the vacuum distillation tank 800. In the illustration of FIG. 3, the refractory tank is buried underground with its top closed end at ground level. The size of the tank shown is 4 feet outer diameter and 10 feet deep.

To dissolve ammonia gas emitted by the water in the vacuum tank, we spray refracted ammonium solution at 805 leading down to the refractory tank 804. A small water pump 806 inside the refractory tank circulates water for spraying at 805.

Valves 807 and 808 control the inflow and outflow of water for the vacuum distillation tank 800. These valves control pressure of the tanks beside water flow. When both valve 807 and 808 are open, water pressure would push refracted ammonium solution inside the refractory tank 804 into the absorption tank 100 in FIG. 1.

Water flow out of the outlet of clean water 802 is controlled by the valve 809. Normally, the valve is open, letting out water from the vacuum chamber into the storage tank 810 that is buried under ground. The storage tank is not always filled. The storage tank is open to the outside atmosphere. Therefore the top of the water in the storage tank is at atmospheric pressure.

The accounting of pressure built up is as follows. The vapor in the space above the head water of the vacuum distillation tank 800 gives out its vapor pressure. The vapor pressure is the sum of water vapor pressure and ammonia vapor pressure determined by the temperature of the vapor at the top. The temperature at the top drops because vaporization requires latent heat of vaporation. Cooled liquid sinks inside the sheath tube 801.

That vapor pressure at the top is added to the pressure of the water column between the water head level inside the vacuum distillation tank 800 and the water head level inside the storage tank 810. The sum of these two pressures should be atmospheric.

The potable water inside the storage tank 810 is pumped out electrically or manual by a small pump 811 to about 4 feet above ground to a spigot or water fountain for human consumption.

We next describe energy storage. We prefer thermal storage of CSP. Melting nitrate salts is an inexpensive, safe, and efficient means of storing heat. Natural gas can provide backup energy if the sun does not shine. I believe that distributed quad-generation by CSP and NG will replace centralized generation of power.

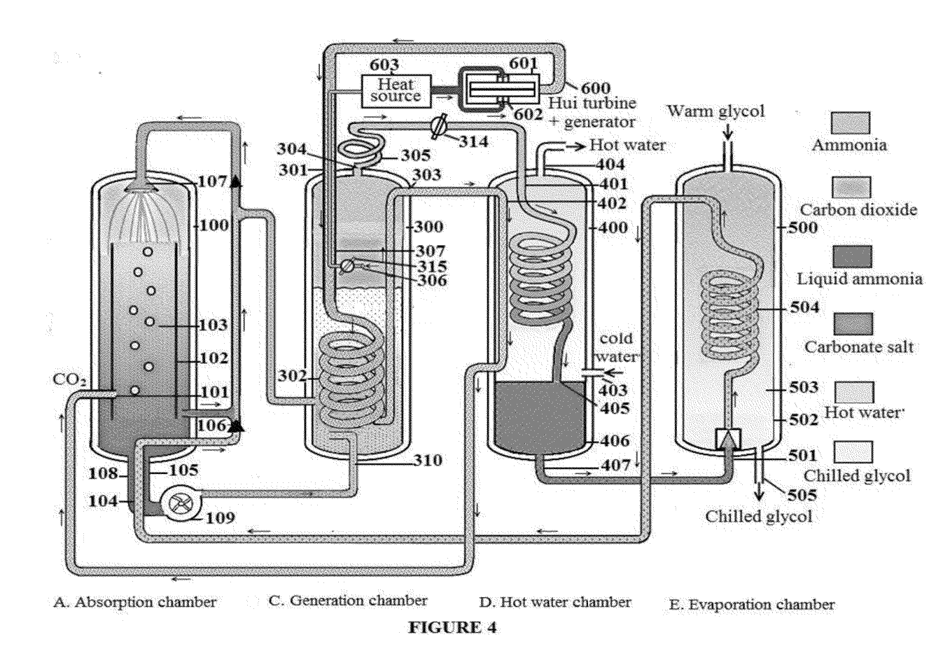

We describe further the reduction of quad-generation. In places where fresh water is readily available, there is no need for the forward osmosis chamber 200. FIG. 4 shows the system without the subsystem of the forward osmosis chamber. Concentrated ammonium carbonate solution can be directly fed with high pressure into the generation chamber, after heat exchange with the exiting water with expelled ammonia and carbon dioxide.

Without dilution of the draw solution, the temperature and energy required to expel ammonia are much reduced. The efficiency of electricity, heat, and chill production is increased.

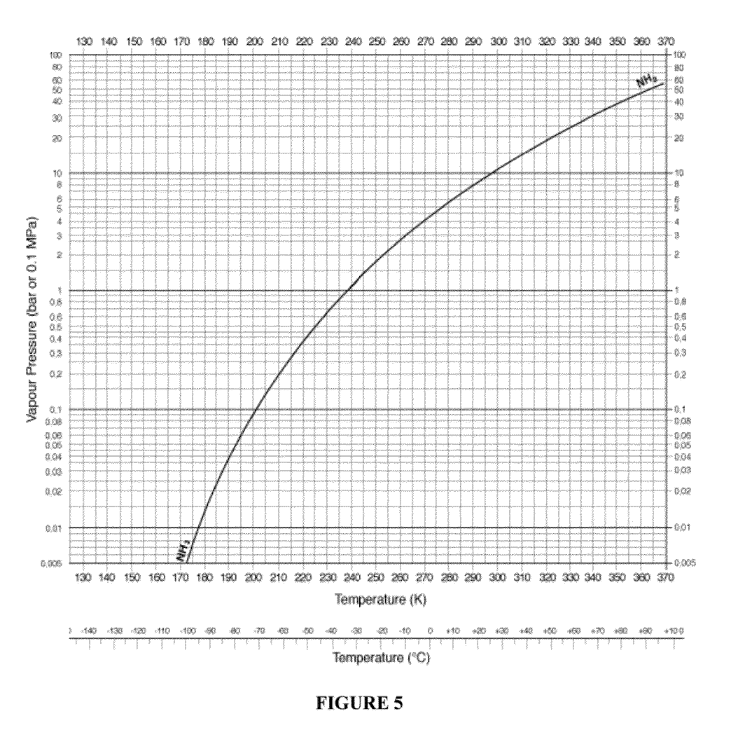

The vapor pressure versus temperature plot of ammonia is shown in FIG. 5. This figure is useful in determining the pressure and temperature for achieving the desired state of ammonia in various chambers.

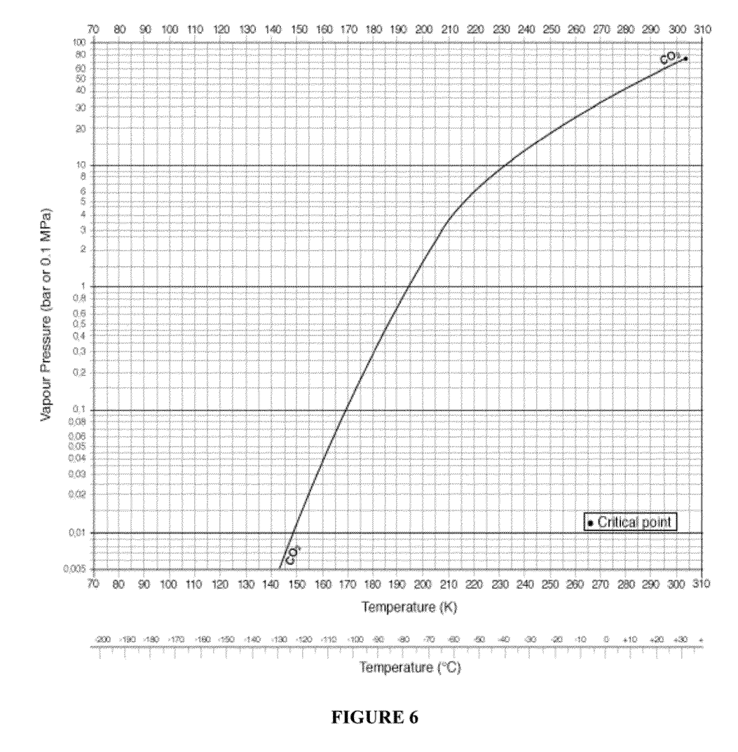

The vapor pressure versus temperature plot of carbon dioxide is shown in FIG. 6. This figure is useful in determining the pressure and temperature for achieving the desired state of carbon dioxide in various chambers.

Modifications, additions, or omissions may be made to the systems, apparatuses, and methods described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. As used in this document, “each” refers to each member of a set or each member of a subset of a set. For the purposes of the claims, terms such as “ammonia” and “carbon dioxide” as well as “evaporating,” “separating,” “liquefying” and “expanding” should be read in the broadest possible sense as understood by one having ordinary skill in the art. Ammonia can refer to ammonia gas, NH₃, NH₄, or any form found under the conditions described, included as an ion for the dilution in a solution or combination in a salt or otherwise with alternative ions. Similarly, carbon dioxide refers to CO₂, as well as combinations of carbon and oxygen, as a stable gas, as well as other forms of C—O combinations in ionic form, dilution, and salt form. The present invention may be run in a closed form, as well as the forms described herein with various inputs and outputs. The piping or conduits serve to connect the various chambers/tanks/containers to allow flow of liquids, gases, and in some cases where possible, undiluted salts and solids, between chambers, as shown. To aid the Patent Office, and any readers of any patent issued on this application in interpreting the claims appended hereto, applicants wish to note that they do not intend any of the appended claims or claim elements to invoke paragraph 6 of 35 U.S.C. Section 112 as it exists on the date of filing hereof unless the words “means for” or “step for” are explicitly used in the particular claim.

I claim:

1. A method for generating electricity and cooling comprising the steps of:
a. leveraging a power source to heat carbon dioxide;
b. converting heat energy from the carbon dioxide to drive a heat engine and generate electricity;
c. providing a solution to absorb ammonia;
d. providing a solution to absorb carbon dioxide;
e. evaporating ammonia from the solution to produce an ammonia gas;
f. evaporating carbon dioxide from the solution to produce a carbon dioxide gas;
g. separating the carbon dioxide gas to be re-heated in said step of leveraging; and
h. liquefying the ammonia gas to provide a liquid ammonia; and
i. expanding of the liquid ammonia to provide cooling.

2. The method of claim 1, whereby the power source is derived from solar energy.

3. The method of claim 1, whereby the step of converting utilizes a Hui Turbine.

4. The method of claim 1, further comprising the steps of:
a. separating the ammonia gas; and
b. routing the ammonia gas through a chamber to transfer heat from the ammonia gas to a liquid within the chamber prior to said step of liquefying the ammonia gas.

5. The method of claim 1, further comprising the step of:
a. routing the carbon dioxide gas through a chamber to transfer heat from the carbon dioxide gas to a liquid within the chamber.

6. The method of claim 1, further comprising the steps of:
a. allowing water from a saltwater solution to pass through a membrane into a draw solution of ammonia;
b. extracting ammonia out of the draw solution to provide potable water.

7. The method of claim 6 wherein the step of extracting ammonia is provided within a vacuum chamber.

8. The method of claim 1 further comprising the step of routing the carbon dioxide, after said step of converting, through a chamber to transfer heat to a liquid within the chamber.

9. A method of generating electricity, cooling, and potable water comprising the steps of:
a. leveraging a power source to heat carbon dioxide;
b. converting heat energy from the carbon dioxide to drive a heat engine and generate electricity;
c. providing a solution to absorb ammonia
d. providing a solution to absorb carbon dioxide;
e. allowing water from a saltwater solution to pass through a membrane into a draw solution of ammonia to provide a diluted ammonia-fortified water solution;
f. extracting ammonia from the ammonia-fortified water solution to produce potable water;
g. evaporating carbon dioxide from the solution to produce a carbon dioxide gas;
h. separating the evaporated carbon dioxide and re-routing the carbon dioxide gas to be re-heated in said step of leveraging; and
i. liquefying ammonia gas to provide a liquid ammonia; and
j. expanding of the liquid ammonia to provide cooling and ammonia gas.

10. The method of claim 9, whereby the power source is derived from solar energy.

11. The method of claim 9, whereby the step of generating utilizes a Hui Turbine.

12. The method of claim 9, further comprising the step of routing ammonia gas through a chamber to transfer heat to liquid within the chamber prior to said step of expanding the of the liquid ammonia.

13. The method of claim 12 further comprising the step of routing the carbon dioxide gas through a chamber to transfer heat to liquid within the chamber.

14. An apparatus for the generation of electricity and cooling, said apparatus comprising:
a. an absorption chamber adapted to provide combination of a refrigerant gas with a heat engine gas into an aqueous solution;
b. a generator for generating electricity through a heat engine with said heat engine gas;
c. a generation chamber adapted to separate said refrigerant gas and said heat engine gas from said aqueous solution;
d. a hot water chamber adapted to allow transfer of heat from said refrigerant gas to a liquid and further adapted to condense said refrigerant gas into a refrigerant liquid;
e. an evaporator chamber adapted to evaporate said refrigerant liquid into said refrigerant gas to provide cooling; and
f. piping adapted to allow said heat engine gas and said refrigerant gas to return to said absorption chamber.

15. The apparatus of claim 14, wherein said heat engine gas comprises carbon dioxide.

16. The apparatus of claim 14, wherein said refrigerant gas comprises ammonia.

17. An apparatus for the generation of electricity, cooling, and potable water, said apparatus comprising:
a. an absorption chamber adapted to provide combination of a refrigerant gas with a heat engine gas into an aqueous solution;
b. a water purification chamber adapted to draw potable water from a salt water solution through a membrane to an aqueous salt solution comprising of refrigerant gas and heat engine gas;
c. a generator for generating electricity through a heat engine with said heat engine gas;
d. a hot water chamber adapted to allow transfer of heat from said refrigerant gas to a liquid and further adapted to condense said refrigerant gas into a refrigerant liquid;
e. an evaporation chamber adapted to evaporate said refrigerant liquid into said refrigerant gas to provide cooling; and
f. piping said heat engine gas and said refrigerant gas to return to said absorption chamber for condensation.

18. The apparatus of claim 17, wherein said heat engine gas comprises carbon dioxide.

19. The apparatus of claim 17, wherein said refrigerant gas comprises ammonia.
